(19) United States
(12) Patent Application Publication
(10) Pub. No.: US 2021/0039939 A1
(43) Pub. Date: Feb. 11, 2021

(54) FUNNEL SYSTEM FOR A GAS TANK

(71) Applicant: STEVE ERICKSON, Cedar Rapids, IA (US)

(72) Inventor: STEVE ERICKSON, Cedar Rapids, IA (US)

(21) Appl. No.: 16/989,863

(22) Filed: Aug. 10, 2020

Related U.S. Application Data
(60) Provisional application No. 62/884,872, filed on Aug. 9, 2019.

(51) Int. Cl. B67C 11/00; B60K 15/04

(52) U.S. Cl. CPC B67C 11/00; B60K 2015/03019; B60K 15/0406

(57) ABSTRACT

A funnel system for a gas tank that can be stored within the gas tank during operation of a machine such as a lawnmower or snow blower. Upon removing the cap of the gas tank in a first embodiment, a funnel is moved toward an open position as the funnel is biased toward the open position. Once fuel is added to the gas tank, a guide member of the cap is utilized to force the funnel toward the closed position and then secured to the gas tank. A second embodiment utilizes a separate guide member, separate from the cap to move the funnel to and from the open position to the closed position.

### CROSS-REFERENCE TO RELATED APPLICATIONS

The present application claims priority to provisional patent application 62/884,872 which was filed on Aug. 9, 2019, and is hereby expressly incorporated by reference in its entirety.

### BACKGROUND OF THE INVENTION

As every owner of a gas-powered lawn mower, snow blower, or any other machine having a gas tank can attest, filling the gas tank from the spout of a gas container can be difficult and lead to spilling of flammable liquids. Taking the additional time to locate and then use a separate funnel is often bypassed, especially when the machine is in need of fuel during a project. More often than not, when the gas tank is being refilled, gas splashes and spills on the top and side of the tank, often enough to drip down on to the machine itself.

The result is that flammable liquid gets splashed near or on hot parts of the machine such as the exhaust, making it an immediate fire hazard. At best, the excess gas will drip off the machine and on to the surface or ground. The dripping itself can be a problem because the surface or the ground can be damaged or discolored.

It is therefore an object of the invention to have a gas tank with an internal funnel housed within the gas tank.

The funnel system will preferably be made of a plastic material that is resistant to petroleum products, as the funnel system will actually have certain parts that remain inside the gas tank. The funnel system includes a funnel that is designed to open like the pedals of a flower. Due in part of its compressed state inside the tank, in one embodiment the funnel will automatically rise up and instantly form a functioning funnel once a cap of the gas tank is removed. The result is that gas can easily and safely be poured into the gas tank without concern of damaging surfaces or creating a fire hazard.

Once the gas tank has been filled, a guide member on the gas cap engages the bottom of the funnel system and pushes the funnel back into the tank. The cap is then securely screwed back on the tank while the funnel resides inside, prepared to rise up the next time the machine needs to be refueled. In a second embodiment, the funnel system has a guide member that is separate from the cap, which allows the funnel system to be added to existing gas tanks.

### BRIEF DESCRIPTION OF THE DRAWINGS

FIG. 1 is a depiction of a funnel system having a gas tank with a cap and the funnel in a closed position;

FIG. 2 is a depiction showing the cap being removed and the funnel moving from the closed position to an open position;

FIG. 3 is a depiction showing fuel being added to the gas tank in a cross-sectional view of the funnel;

FIG. 4 is a depiction showing fuel being added to the gas tank showing the funnel;

FIG. 5 is a depiction of the funnel system from a top perspective view;

FIG. 6 is a perspective view of a second embodiment of a funnel system;

FIG. 7 is a perspective view of a guide member of the second embodiment;

FIG. 8 is a front view of the second embodiment.

### DETAILED DESCRIPTION OF THE INVENTION

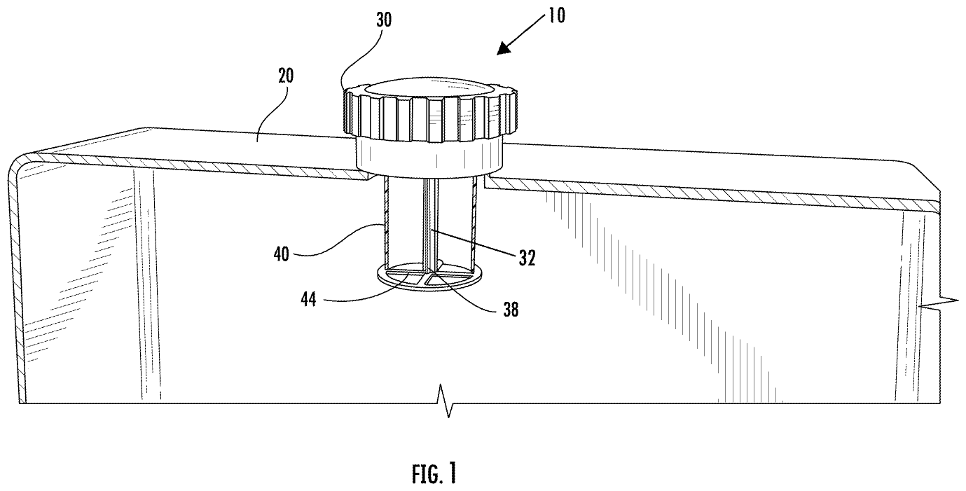

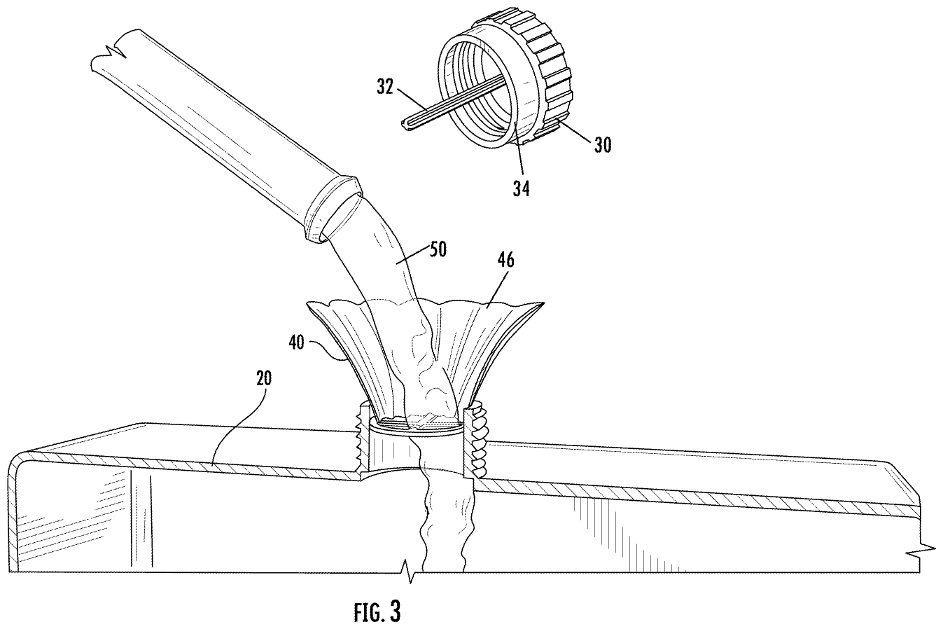

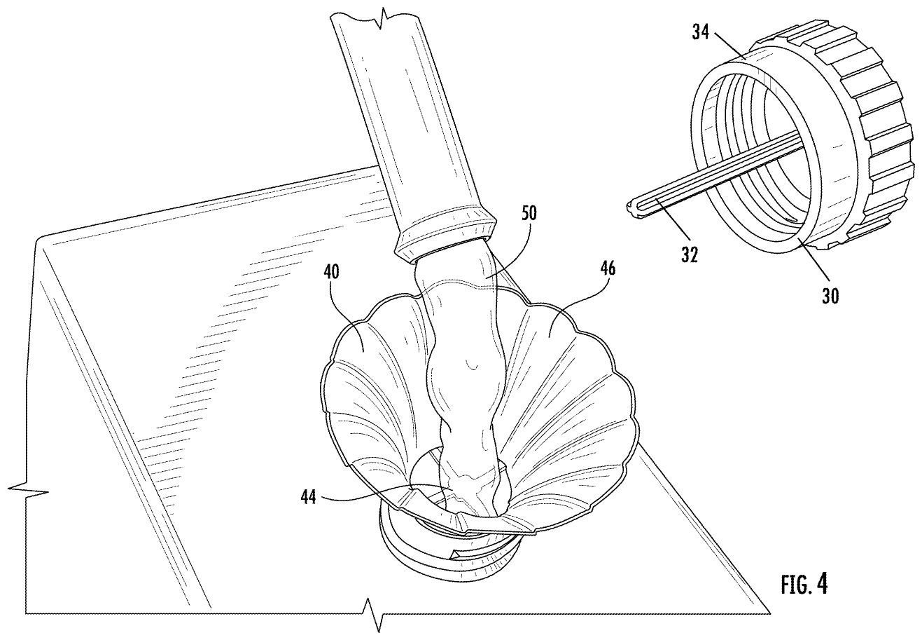

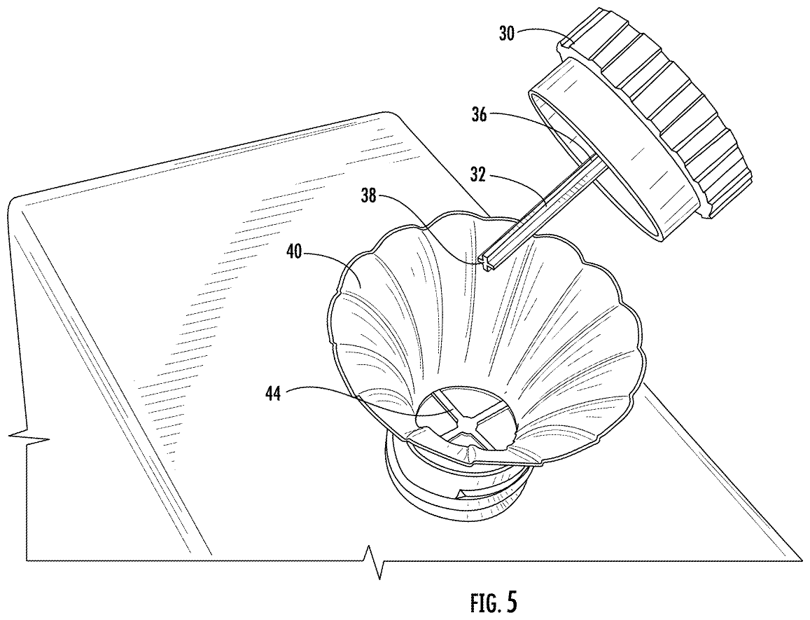

Now referring to the figures, a funnel system 10 for a gas tank 20 is described. In a first embodiment of the funnel system 20, FIGS. 1-5 show the funnel system 10 comprising a funnel 40 that is at least partially held within the gas tank 20 and selectively stored within the gas tank 20 when the funnel 10 is not in use. The funnel system 10 has a first position when a cap 30 is secured to the gas tank 20. The first position of the funnel system 10 represents a closed position for the funnel 40.

Upon removal of the cap 30, the funnel 40 moves from the first position to a second position. The second position of the funnel 40 and funnel system 10 represents an open position. Preferably the funnel 40 is biased toward the open position. Accordingly, once the cap 30 is removed the funnel 40 automatically extends toward the second position.

The funnel 40 has a plurality of flaps 46. The flaps 46 are attached to a base member 44. Once in the open position, fuel 50 can be added and the funnel 40 directs 11 the fuel 50 into the interior of the gas tank 20.

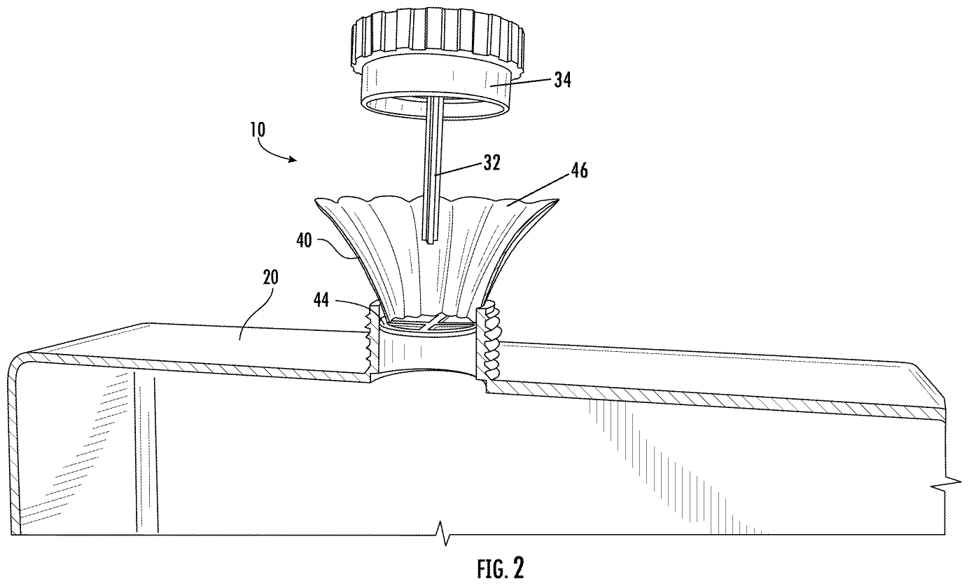

As best seen in FIG. 2, the cap 30 preferably has a guide member 32 extending from a main body 34 of the cap 30. The guide member 32 has a first end 36 and a second end 38. The second end 38 can push the base member 44 of the funnel 40 toward the closed position. As the funnel 40 is attached to the base member 44, the plurality of flaps 26 overlap more and the funnel 40 returns to the closed position within the gas tank 20.

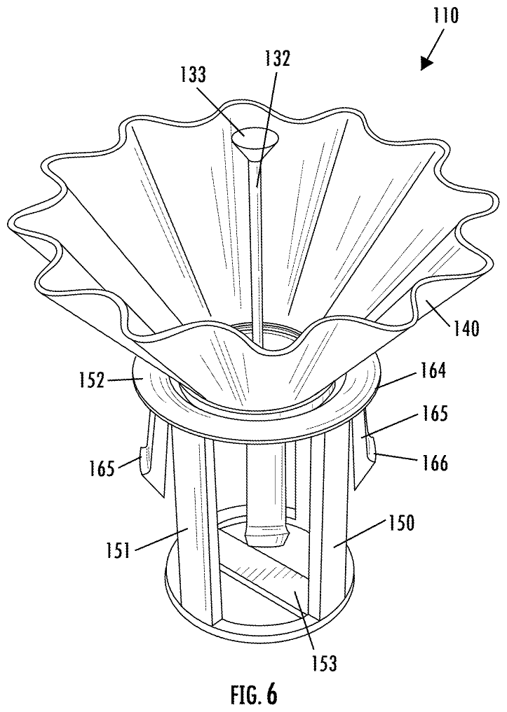

In FIGS. 6-8, a second embodiment of a funnel system 110 for a gas tank is shown. The second embodiment is the preferred embodiment. The funnel system 110 includes a funnel 140, a guide member 132 and a frame 150. The funnel 140 is preferably made of a flexible material so the funnel 140 can be moved from a first position to a second position. The first position corresponds to a closed position, while the second position corresponds to an open position.

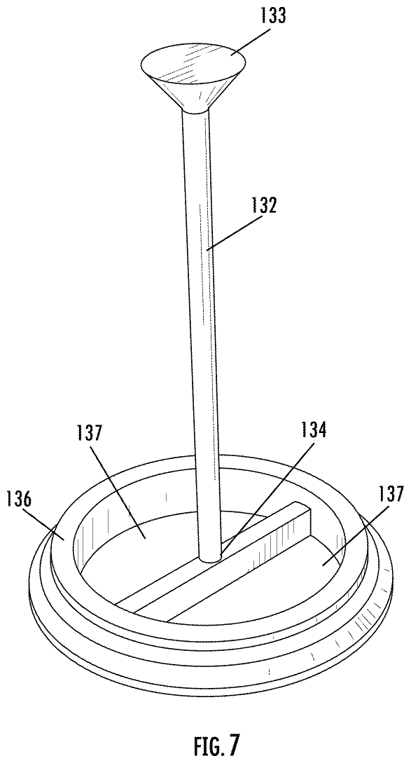

FIG. 6 shows the funnel system 110 and the funnel 140 in an open position. The funnel 140 extends out of the gas tank. A user can then pour gasoline or some other liquid into the gas tank. As best shown in FIG. 7, the guide member 132 has a first end 133 and a second end 134. The second end 134 of the guide member 132 comprises a base 136. The base 136 has openings 137 such that gasoline can enter the gas tank.

As best shown in FIG. 6, the frame 150 has connecting members 151 that connect a top 152 of the frame 150 to a bottom 153 of the frame 150. The guide member 132 is movable within the frame 150. The base 136 of the guide member 132 can be moved from the bottom 153 of the frame 150 towards the top 152 of the frame 150. The funnel 140 is housed at least partially within the frame 150 and the gas tank when the funnel system 110 and the funnel 140 are in the first position or closed position. The funnel 140 is at least partially outside of the frame 150 and the gas tank when the funnel system 110 and the funnel 140 are in the second position or open position. A user of the funnel system 110 can utilize a force to push or pull the guide member 132. When the funnel system 110 is in the closed position, the user pulls up on the guide member 132 to place the funnel system 110 and funnel 140 into the open position. When the funnel system 110 is in the open position, the user pushes the guide member 132 downward toward the bottom 153 of the frame 150. The funnel 140 folds down and is then stored within the frame 150 and the gas tank.

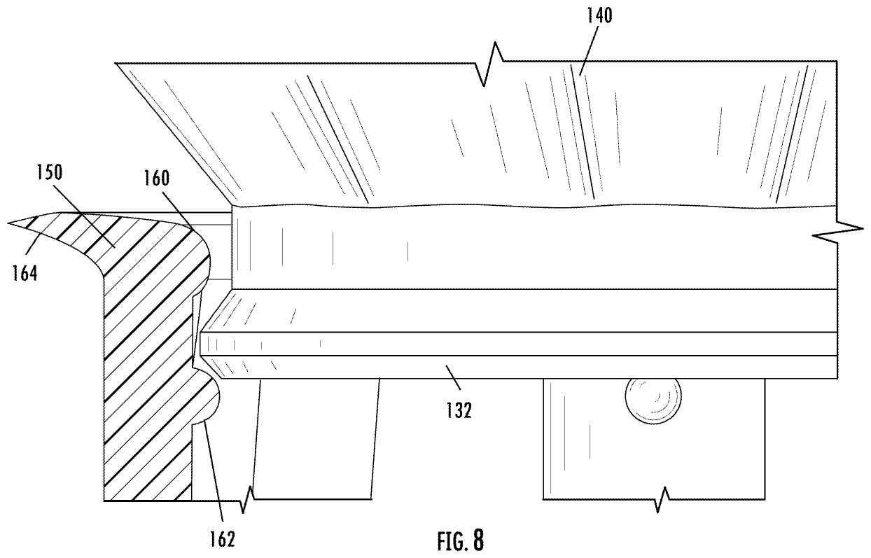

As best shown in FIGS. 6 and 8, the frame 150 includes features to enhance the functionality of the funnel system 110 and to assist in maintaining certain positions of the frame 150 and guide member 132. The frame 150 has a lip 164 that prevents the frame 150 and the funnel system 110 from falling down into the gas tank. Additionally, the frame 150 includes a plurality of securing members 165. The plurality of securing members 165 are flexible and include a hook 166. The hook 166 prevents the frame 150 from being lifted out of the gas tank. The frame 150 also has a first retaining member 160 and a second retaining member 162. The first retaining member 160 prevents the guide member 132 from being pulled outside of the gas tank. Specifically, the first retaining member 160 interacts with the base 136 of the guide member 132. The second retaining member 162 allows the base 136 of the guide member 132 to maintain the funnel system 110 in the open position. The user must utilize a certain downward force to overcome the friction between the base 136 and the second retaining member 162 to return the funnel 140 and funnel system 110 to the closed position.

Having thus described the invention in connection with the several embodiments thereof, it will be evident to those skilled in the art that various revisions can be made to the several embodiments described herein without departing from the spirit and scope of the invention. It is my intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

What is claimed is:

1. A funnel system for a gas tank, comprising:
a funnel;
a cap;
the funnel at least partially inside the gas tank when the cap is secured on the gas tank;
the funnel configured to be biased to at least partially be outside of the gas tank when the cap is removed from the gas tank;
the funnel system in a first position when the cap is secured on the gas tank;
the funnel system in a second position when the cap is removed from the gas tank.

2. The funnel system of claim 1, wherein:
the cap has a guide member;
the guide member has a first end and a second end;
wherein the second end of the guide member can force the funnel downward towards the first position.

3. The funnel system of claim 2, further comprising:
a base member;
the base member connected to the funnel.

4. The funnel system of claim 3, wherein:
the second end of the guide member selectively contacts the base member to force the funnel toward the first position.

5. The funnel system of claim 4, wherein:
the funnel comprises a plurality of flaps that can be configured to overlap one another.

6. The funnel system of claim 5, wherein:
the plurality of flaps is the source of the biasing force to move the funnel from the first position to the second position.

7. A funnel system for a gas tank, comprising:
a funnel;
a guide member;
the funnel at least partially inside the gas tank when the guide member is in a first position;
the funnel at least partially outside the gas tank when the guide member is in a second position.

8. The funnel system of claim 7, wherein:
the funnel is made of a flexible material.

9. The funnel system of claim 8, further comprising:
a frame;
the frame configured to hold the guide member.

10. The funnel system of claim 9, wherein:
the frame comprises at least one securing member;
the securing member prevents the frame from being removed from the gas tank.

11. The funnel system of claim 10, wherein:
the frame further comprises a lip;
the lip prevents the funnel system from falling into the gas tank.

12. The funnel system of claim 11, wherein:
the guide member has a base.

13. The funnel system of claim 12, wherein:
the frame comprises a first retaining member;
the first retaining member prevents the base from being dislocated from the frame.

14. The funnel system of claim 13, wherein:
the frame comprises a second retaining member;
the second retaining member configured to hold the base member in a defined position.

15. The funnel system of claim 14, wherein:
the funnel is connected to the base member.

16. A funnel system for a gas tank, comprising:
a funnel;
a guide member;
a frame;
the guide member movable within the frame from a first position to a second position;
the funnel in an open position when the guide member is in the second position;
the funnel in a closed position when the guide member is in the first position.

17. The funnel system of claim 16, wherein:
the guide member has a base;
the frame comprises at least one securing member;
the securing member prevents the frame from being removed from the gas tank.

18. The funnel system of claim 17, wherein:
the frame further comprises a lip;
the lip prevents the funnel system from falling into the gas tank.

19. The funnel system of claim 18, wherein:
the guide member has a base.

20. The funnel system of claim 19, wherein:
the frame comprises a first retaining member;
the first retaining member prevents the base from being dislocated from the frame.
